(19) United States
(12) Patent Application Publication
(10) Pub. No.: US 2007/0046417 A1
(43) Pub. Date: Mar. 1, 2007

(54) ELECTRICAL CONNECTOR HOUSING AND METHOD OF PRODUCING SAME

(75) Inventors: Slobadan Pavlovic, Canton, MI (US); Mohamad Zeidan, Dearborn Heights, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 11/161,931

(22) Filed: Aug. 23, 2005

(51) Int. Cl. H01H 85/02; H01H 85/20; H01H 85/46

(52) U.S. Cl. 337/187

(57) ABSTRACT

A fuse holder for an electrical fuse includes a first housing portion which has first and second electrical terminals disposed therein. A second housing portion is pivotally attached to the first housing portion, and is configured to carry the electrical fuse. Pivoting the first and second housing portions together automatically and sequentially connects the fuse carried by the second housing portion to the terminals disposed within the first housing portion. This provides a convenient mechanism for connecting and disconnecting the fuse, and facilitates the use of a fuse without its own insulating material.

### BACKGROUND OF THE INVENTION

1. Field of the Invention

The present invention relates to an electrical connector housing, and a method of producing an electrical connector housing.

2. Background Art

Electrical circuits often include an electrical connector in the form of a fuse, which is designed to break the circuit upon the occurrence of a specified event—e.g., too much current flowing through the circuit. Some fuses utilize bolt-on connections which require utilization of torque guns or other tools to apply the appropriate torque to the bolts during installation of the fuse. In addition to adding complexity to the production, and potentially increasing costs, bolt-on fuse connections may fail if an improper torque has been applied during installation. This may be particularly true in rigorous automotive environments.

Other types of fuse solutions include fusible links, which may be prone to heat damage in an automotive environment, and can also have a high cost of service. In addition, using a fuse which includes its own insulating cover adds cost to the fuse because of the extra material and the increased complexity in production. Therefore, it would be desirable to have an electrical connector housing, such as a fuse holder, which eliminated the need for bolt-on fuse connections, and also facilitated the use of fuses devoid of insulating material.

### SUMMARY OF THE INVENTION

The present invention provides an electrical connector housing which includes a first housing portion and a second housing portion. The first housing portion includes first and second electrically conducting elements, each of which has a first connector portion which is configured to cooperate with an electrical connector to electrically connect the first and second electrically conducting elements. At least one of the first and second electrically conducting elements is integrally formed with the first housing portion. The second housing portion is configured to cooperate with the first housing portion to at least partially enclose the first connector portion of each of the first and second electrically conducting elements and the electrical connector when the electrical connector is positioned to electrically connect the first and second electrically conducting elements.

The invention also provides a fuse holder for an electrical fuse, which includes a first housing portion having first and second electrical terminals. A second housing portion is configured to carry the electrical fuse, and is further configured to cooperate with the first housing portion such that the fuse carried by the second housing portion automatically electrically connects the first and second terminals when the first and second housing portions are disposed proximate each other in a first mating position.

The invention further provides a method of producing an electrical connector housing having first and second electrically conducting elements. The method includes molding a first housing portion defining an interior space. Each of the first and second electrically conducting elements includes a first connector portion disposed substantially within the interior space. The method also includes molding a second housing portion which is configured to cooperate with the first housing portion in a first mating position. The second housing portion includes a retaining structure configured to retain an electrical connector such that the electrical connector electrically connects the first and second electrically conducting elements when the first and second housing portions are placed in the first mating position.

### BRIEF DESCRIPTION OF THE DRAWINGS

FIG. 1 shows an exploded view of an electrical connector housing and an electrical connector in the form of a fuse, in accordance with one embodiment of the present invention;

FIG. 2 shows a partial fragmentary assembled view of the electrical connector housing and fuse shown in FIG. 1;

FIG. 3 shows an isometric view of the electrical connector housing and fuse shown in FIG. 1, with a first housing portion unlatched from a second housing portion;

FIG. 4 shows an isometric view of the electrical connector housing shown in FIG. 3, with the first and second housing portions in a first mating position;

FIG. 5A shows a partial fragmentary exploded view of a fuse holder cover and fuse in accordance with another embodiment of the present invention;

FIG. 5B shows a partial fragmentary assembled view of the fuse holder cover and fuse shown in FIG. 5A; and

FIG. 6 shows an isometric view of an electrical connector housing in accordance with another embodiment of the present invention.

### DETAILED DESCRIPTION OF THE PREFERRED EMBODIMENT(S)

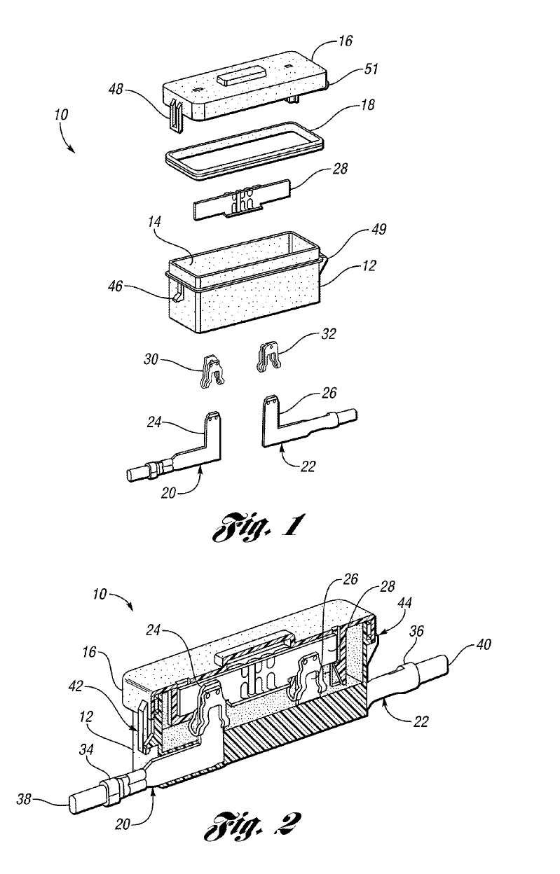

FIG. 1 shows an exploded view of an electrical connector housing, or fuse holder 10, in accordance with one embodiment of the present invention. The fuse holder 10 includes a first housing portion, or base 12, which defines an interior space 14. The fuse holder 10 also includes a second housing portion, or cover 16, and a seal 18 configured to be disposed between the base 12 and the cover 16. The fuse holder 10 also includes first and second electrically conducting elements, or terminals 20, 22. As shown in FIG. 1, the terminals 20, 22 are male terminals, which respectively include first connector portions 24, 26. As described more fully below, the first connector portions 24, 26 are configured to cooperate with an electrical connector, such as a fuse 28, to electrically connect the first and second terminals 20, 22. Also shown in FIG. 1 are first and second electrical attachment features, or female terminals 30, 32. The female terminals 30, 32 are spring terminals configured to be disposed on the first connector portions 24, 26 of the male terminals 20, 22; they are also configured to receive the fuse 28, which in the embodiment shown in FIG. 1, is a male connector.

FIG. 2 shows a partial fragmentary view of the fuse holder 10 with all of the components assembled. One method of producing the fuse holder 10 is to mold the base 12 from a polymeric or composite material. In automotive applications, where heat resistence is required, a polyamide with a 30% glass field has been shown to be effective. Of course, other materials may be used, including other polymers and composites, depending on the particular application. In the embodiment shown in FIG. 2, the terminals 20, 22 are integrally formed with the base 12. This can be done by a technique commonly known as “overmolding”. Integrally molding the terminals 20, 22 with the base 12, provides a robust method of attachment, and isolates the fuse 28 from outside stresses, thereby providing a built-in strain relief.

The use of the separate female terminals 30, 32, which are installed after the base 12 is molded, helps to facilitate the overmolding process by reducing the complexity of the setup and/or tooling. In order to provide a good electrical contact surface, the first contact portions 24, 26 must be free of the material used to mold the base 12—e.g., the polyamide/glass material. Male terminals, such as the terminals 20, 22, are easier to shield from the molded material, and the female terminals 30, 32 are quickly and easily applied to the first contact portions 24, 26 after the base 12 is molded.

As shown in FIG. 2, each of the male terminals 20, 22 also includes a second connector portion 34, 36, respectively. The second connector portions 34, 36 are each configured to retain a wire 38, 40. As discussed below, the second connector portions can be configured in virtually any shape effective to provide a connection point to another electrically conducting element, such as, a crimp terminal, a welding interface, or an eyelet or ring terminal. In the embodiment shown in FIG. 2, the second connector portions 34, 36 are oriented generally perpendicular to their respective first connector portions 24, 26. This may further help to reduce stress and/or strain on the fuse 28, because more of the terminals 20, 22 are molded into the base 12.

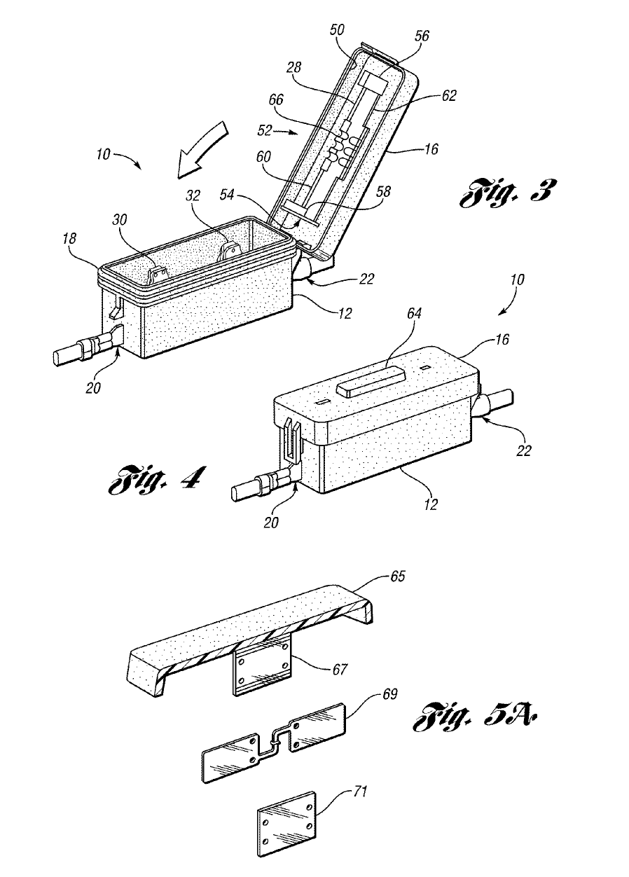

As shown in FIG. 2, the base 12 and the cover 16 cooperate with each other in a first mating position which is maintained by a latch mechanism 42 on one side, and a hinge mechanism 44 on the other. The latch mechanism 42 includes an attachment structure 46 and a receiving structure 48 (see FIG. 1) respectively molded with the base 12 and the cover 16. The receiving structure 48 is configured to receive the attachment structure 46 to help secure the base 12 to the cover 16. The hinge mechanism 44 includes first and second portions 49, 51 (see FIG. 1) also respectively molded with the base 12 and the cover 16. The hinge mechanism 44 allows the base 12 and the cover 16 to pivot relative to each other, which is best illustrated in FIG. 3.

Turning to FIG. 3, an inner portion 50 of the cover 16 is visible. The cover 16 includes a retaining structure 52 which includes first and second portions, or retaining elements 54, 56. The first retaining element 54 includes a lip 58 under which one end of the fuse 28 is placed. The other end of the fuse 28 is snapped into the second retaining element 56, which in the embodiment shown in FIG. 3, is configured as a clip. Like the base 12, and even the seal 18, the cover 16 may be conveniently molded of an appropriate material, such as a heat resistant polymer or composite. This allows the retaining structure 52 to be integrally molded with the cover 16, thereby eliminating the need for a separate assembly operation.

Once the fuse 28 is secured within the retaining structure 52, the cover 16 can be pivoted into the first mating position with the base 12. This movement is illustrated by the directional arrow shown in FIG. 3. As can be readily discerned from FIG. 3, the fuse 28 will be sequentially connected to the two terminals 20, 22 in the base 12 as the base 12 and the cover 16 are brought together into the first mating position. Specifically, a first portion 60 of the fuse 28 will be received by the female terminal 32 in the base 12. After contact is made, a second portion 62 of the fuse 28 will be received by the other female terminal 30. Thus, the fuse 28 may be connected to the female terminals 30, 32 one at a time, which reduces the insertion force necessary to connect the fuse 28 with the terminals 30, 32.

The retaining structure 52 is configured to hold the fuse 28 to allow it to be automatically connected to the terminals 30, 32 when the base 12 and the cover 16 are pivoted together into the first mating position. Similarly, the retaining structure 52 will retain the fuse 28 when the base 12 and the cover 16 are pivoted out of the first mating position. Thus, pivoting the cover 16 away from the base 12 will automatically disconnect the fuse 28 from the terminal 30, and then from the terminal 32, in reverse order of their connection. The configuration of the fuse holder 10 eliminates the requirement for insulation on a fuse that would otherwise be used to grip the fuse as it is inserted into an electrical circuit.

As shown in FIGS. 1-3, the fuse 28 is an all metal fuse, devoid of insulation. The cover 16 can be molded from a material which not only provides heat resistance for automotive environments, but also provides electrical insulation to isolate the fuse 28 from an operator opening or closing the housing 10. When the fuse 28 needs replacing, it is only necessary to replace the metal fuse 28 itself; the cover 16 may be reusable, in which case a new fuse is secured within the retaining structure 52 after the fuse 28 is removed. Alternatively, a number of covers, such as the cover 16, can be pre-loaded with fuses so that replacement of a fuse merely requires replacement of the cover—the fuse need never be removed from the retaining structure.

In FIG. 4, the base 12 and the cover 16 are shown in the first mating position. When they are in the first mating position, the base 12 and the cover 16 provide a substantially sealed enclosure for the fuse 28 and the associated electrical terminals 20, 22 and 30, 32. Also shown in FIG. 4, the cover 16 includes a protrusion 62 molded therein to accommodate a protruding portion 66 of the fuse 28 (see also FIG. 3). Although the housing portions 12, 16 do not need to be molded, or made from a polymeric material, it does provide a convenient method for producing a fuse holder, such as the fuse holder 10. Not only can the geometric configuration of the fuse holder 10 be modified to accommodate different styles of fuses and/or electrical terminals, but an appropriate choice of a polymeric material effectively insulates the electrical connectors, and eliminates the need to use a fuse having its own insulation.

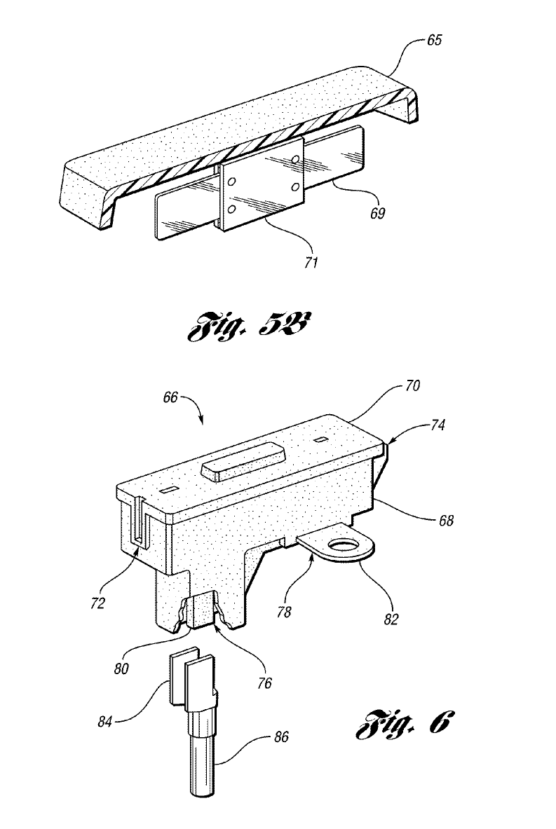

FIG. 5A shows a portion of a second housing portion, or fuse holder cover 65, having a retaining structure that is different from the one shown in FIG. 3. Although the cover 65 is shown without latch and hinge mechanisms, such as the latch and hinge mechanisms 42, 44 shown in FIG. 2, it is understood that it may contain these or other attachment features so that it can cooperate with a base portion of a fuse holder. Integrally molded with the cover 65 is a first portion 67 of a retaining structure configured to carry a fuse 69. Separate from the first portion 67 is a second portion 71 of the retaining structure. Although the second portion 71 is separate from the cover 65, it could be molded substantially simultaneously with the cover 65, for example, in a separate cavity of the same mold tool.

As shown in FIG. 5B, the first and second portions 67, 71 of the retaining structure cooperate to capture the fuse 69 between them. One convenient method of attaching the first and second portions 67, 71 together is to sonic weld them to each other. Alternatively, they could be heat-staked, or an adhesive could be used, depending on the particular application. As noted above, one convenient method of using a fuse holder in accordance with the present invention is to secure fuses into a number of respective fuse holder covers, such as the cover 65, and when a fuse needs replacing, the entire cover, including the fuse, is replaced.

FIG. 6 shows an electrical connector housing, or fuse holder 66 in accordance with another embodiment of the present invention. Similar to the fuse holder 10, the fuse holder 66 includes first and second housing portions 68, 70 which cooperate with each other in a first mating position, as shown in FIG. 5. A latch mechanism 72 and a hinge mechanism 74 allow the first and second housing portions 68, 70 to be pivoted relative to each other, and securely latched in the first mating position. Although not visible in FIG. 6, first and second terminals 76, 78 each have first connector portions which are configured to receive female terminals to facilitate connection to a fuse, such as the fuse 28. In contrast to the fuse holder 10, the terminals 76, 78 have markedly different second connector portions 80, 82, respectively. The second connector portion 80 of the first terminal 76 is a thick male terminal that is configured to receive a fork terminal 84, which may be attached to an electrically conducting element, such as a wire 86. The second connector portion 82 of the second terminal 78 is a ring terminal, which facilitates secure attachment to another electrically conducting element (not shown) through the use of a bolt, or other stud-type fastener. It is worth noting that the embodiment shown in FIG. 6 represents just one variation of many different varieties of terminals which may be used with a fuse holder, in accordance with the present invention.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. An electrical connector housing, comprising:
a first housing portion including first and second electrically conducting elements, each of the first and second electrically conducting elements having a first connector portion configured to cooperate with an electrical connector to electrically connect the first and second electrically conducting elements, at least one of the first and second electrically conducting elements being integrally formed with the first housing portion; and
a second housing portion configured to cooperate with the first housing portion to at least partially enclose the first connector portion of each of the first and second electrically conducting elements and the electrical connector when the electrical connector is positioned to electrically connect the first and second electrically conducting elements.

2. The electrical connector housing of claim 1, further comprising first and second electrical attachment features configured for respective attachment to the first connector portion of the first and second electrically conducting elements, and further configured for attachment to the electrical connector, thereby facilitating an electrical connection between the first and second electrically conducting elements and the electrical connector.

3. The electrical connector housing of claim 1, wherein the first and second housing portions are configured to cooperate in a first mating position, and the second housing portion is further configured to retain the electrical connector therein such that the electrical connector is automatically electrically connected to the first and second electrically conducting elements when the first and second housing portions are in the first mating position.

4. The electrical connector housing of claim 3, wherein each of the first and second electrically conducting elements is integrally formed with the first housing portion, and each of the first and second electrically conducting elements includes a second connector portion accessible from outside the first housing portion when the first and second housing portions are in the first mating position, each of the second connector portions being disposed generally perpendicular to a respective first connector portion, thereby reducing strain on the electrical connector when it is electrically connected to the first and second electrically conducting elements.

5. The electrical connector housing of claim 3, wherein the electrical connector includes a metal fuse element substantially devoid of insulating material.

6. The electrical connector housing of claim 3, wherein the first and second housing portions are pivotally attached to each other such that pivoting one of the housing portions into the first mating position with the other housing portion, when the electrical connector is retained by the second housing portion, electrically connects the electrical connector to the first and second electrically conducting elements sequentially.

7. The electrical connector housing of claim 6, wherein the second housing portion is further configured to retain the electrical connector therein such that the electrical connector is automatically electrically disconnected from at least one of the first and second electrically conducting elements when one of the housing portions is pivoted out of the first mating position with the other housing portion.

8. A fuse holder for an electrical fuse, the fuse holder comprising:
a first housing portion including first and second electrical terminals; and
a second housing portion configured to carry the electrical fuse, and being further configured to cooperate with the first housing portion such that the fuse carried by the second housing portion electrically connects the first and second terminals when the first and second housing portions are disposed proximate each other in a first mating position.

9. The fuse holder of claim 8, wherein one of the housing portions includes an attachment structure and the other one of the housing portions includes a receiving structure configured to receive the attachment structure for at least partially securing the first and second housing portions to each other in the first mating position.

10. The fuse holder of claim 8, wherein the second housing portion comprises a molded structure having a first portion of a retaining structure integrally molded therewith, the fuse holder further comprising a second portion of the retaining structure configured to cooperate with the first portion of the retaining structure to carry the fuse.

11. The fuse holder of claim 8, wherein at least one of the first and second terminals is a male terminal, the fuse holder further comprising at least one female electrical terminal configured for electrical connection to a corresponding male terminal, and further configured for electrical connection to the fuse.

12. The fuse holder of claim 8, wherein the first and second housing portions are pivotally attached to each other such that pivoting one of the housing portions into the first mating position with the other housing portion, when the fuse is carried by the second housing portion, electrically connects the fuse to the first and second terminals sequentially.

13. The fuse holder housing of claim 12, wherein the second housing portion is further configured such that the fuse is automatically electrically disconnected from at least one of the first and second terminals when one of the housing portions is pivoted out of the first mating position with the other housing portion.

14. The fuse holder housing of claim 8, further comprising a seal configured to be disposed between the first and second housing portions in the first mating position, thereby providing a substantially sealed enclosure for the fuse.

15. The fuse holder housing of claim 8, wherein each of the first and second terminals is integrally formed with the first housing portion, and each of the first and second terminals includes a second connector portion accessible from outside the first housing portion when the first and second housing portions are in the first mating position, each of the second connector portions being disposed generally perpendicular to a respective first connector portion, thereby reducing strain on the fuse when it is electrically connected to the first and second terminals.

16. A method of producing an electrical connector housing including first and second electrically conducting elements, the method comprising:
molding a first housing portion defining an interior space, each of the first and second electrically conducting elements including a first connector portion disposed substantially within the interior space; and
molding a second housing portion configured to cooperate with the first housing portion in a first mating position, the second housing portion including at least a portion of a retaining structure integrally molded therewith and configured to retain an electrical connector such that the electrical connector automatically electrically connects the first and second electrically conducting elements when the first and second housing portions are placed in the first mating position.

17. The method of claim 16, wherein a first portion of the retaining structure is integrally molded with the second housing portion, the method further comprising:
molding a second portion of the retaining structure separate from the second housing portion; and
attaching the first and second portions of the retaining structure to each other such that the electrical connector is retained therebetween.

18. The method of claim 16, further comprising molding the first and second electrically conducting elements into the first housing portion.

19. The method of claim 16, each of the first and second electrically conducting elements being a male electrical terminal, and the electrical connector being a male connector, the method further comprising disposing first and second female electrical terminals over a respective male terminal to facilitate electrical connection between the male terminals and the male connector.

20. The method of claim 16, further comprising molding hinge elements into the first and second housing portions such that the first and second housing portions cooperate in a pivoting relationship such that pivoting one of the housing portions into the first mating position with the other housing portion, when the electrical connector is retained by the second housing portion, automatically electrically connects the electrical connector to the first and second electrically conducting elements sequentially.
